(19) United States
(12) Patent Application Publication
(10) Pub. No.: US 2026/0301412 A1
(43) Pub. Date: Oct. 1, 2026

(54) VEHICLE INFORMATION PRESENTATION APPARATUS, VEHICLE INFORMATION PRESENTATION METHOD, AND NON-TRANSITORY COMPUTER READABLE MEDIUM FOR VEHICLE INFORMATION PRESENTATION PROGRAM

(71) Applicant: Honda Motor Co., Ltd., Tokyo (JP)

(72) Inventors: Hiroshi Honda, Tokyo (JP); Ko Uchida, Tokyo (JP); Tameaki Honda, Tokyo (JP); Kazuki Yoshigai, Tokyo (JP); Shotaro Nishimura, Tokyo (JP); Yosuke Fuchiwaki, Tokyo (JP)

(21) Appl. No.: 19/574,315

(22) Filed: Mar. 21, 2026

(30) Foreign Application Priority Data
Mar. 27, 2025 (JP) 2025-052857

(51) Int. Cl. G06V 20/52; G06F 3/16; G06V 10/70; G06V 20/59; G06V 40/10

(52) U.S. Cl. CPC G06V 20/52; G06V 10/70; G06V 20/59; G06V 40/10; G06F 3/167

(57) ABSTRACT

A vehicle information presentation apparatus includes: an imaging device capturing an interior of a vehicle and outputting an in-vehicle image; and a microprocessor. The microprocessor performs: individually detecting an occupant inside the vehicle from the in-vehicle image; individually detecting an object present in the vehicle from the in-vehicle image; when it is detected from the in-vehicle image that the object has been moved by the occupant based on a detection result of the occupant and a detection result of the object, combining occupant information identifying the occupant who moved the object, object information identifying the object moved, and destination information identifying a destination position of the moved object and storing combined information in a memory, and presenting object position information, the object position information being information regarding a position of the object in the interior of the vehicle, to the occupant based on the combined information.

### CROSS-REFERENCE TO RELATED APPLICATION

This application is based upon and claims the benefit of priority from Japanese Patent Application No. 2025-052857 filed on Mar. 27, 2025, the content of which is incorporated herein by reference.

### BACKGROUND

### Technical Field

The present disclosure relates to a technique for detecting a position of an object present in a vehicle and presenting the detected position to an occupant.

### Related Art

There is known a technique in which, when a user who has finished using a vehicle for car sharing returns the vehicle to a return location and tries to leave the vehicle, the user is notified of a lost article on a floor or a seat in the vehicle by detecting the lost article. The vehicle interior inspection device disclosed in JP 2013-191053 A includes a means by which an automobile can detect an own vehicle position and a photographing means for photographing a current state in the vehicle as current video data. Then, the current position of the vehicle is compared with preset position data, and in a case where the current position and the preset position data coincide with each other, the photographing means is instructed to photograph the current video data, the current video data is compared with predetermined comparison video data stored in advance, and in a case where a difference is detected between the current video data and the predetermined comparison video data, a predetermined message is sent into the automobile based on the difference.

Vehicles for car sharing are used by an unspecified number of users. Therefore, when the user who has finished using the vehicle leaves an article in the vehicle and leaves the place, there is a high possibility that the article is a lost article.

In a case where a photographing means provided in a vehicle attempts to detect an article left behind (lost article) in the vehicle, a blind spot when the photographing means photographs an image of the vehicle interior becomes a problem. In particular, there is a possibility that a target article cannot be captured due to a blind spot when attempting to capture a relatively small article left behind such as a smartphone by a photographing means. For example, in a case where a passenger sitting on the rear seat puts a smartphone into a seat back pocket of the front seat or a smartphone that has slipped out from a bag enters under a center armrest of the rear seat, it is difficult to detect the position of the smartphone from an image captured by the photographing means.

In addition, in a case where the vehicle is owned by the user, there may be an article that may be left unattended in the vehicle without any problem when the user returns home after using the vehicle. For example, a box containing tissue paper is an article that can be left unattended in the vehicle without any problem when the occupant gets off the vehicle. Conversely, even if the article is usually left in the vehicle, it may sometimes be desirable for the passenger to take out the article when getting off the vehicle in a specific situation.

### SUMMARY

An aspect of the present invention is a vehicle information presentation apparatus including: an imaging device configured to capture an interior of a vehicle and output an in-vehicle image; a microprocessor; and a memory connected to the microprocessor. The microprocessor is configured to perform: individually detecting an occupant inside the vehicle from the in-vehicle image; individually detecting an object present in the vehicle from the in-vehicle image; when it is detected from the in-vehicle image that the object has been moved by the occupant based on a detection result of the occupant and a detection result of the object, combining occupant information identifying the occupant who moved the object, object information identifying the object moved, and destination information identifying a destination position to which the object has been moved, and storing combined information as first information in the memory, and presenting object position information, the object position information being information regarding a position of the object in the interior of the vehicle, to the occupant based on the first information.

Another aspect of the present invention is a vehicle information presentation method including: acquiring an in-vehicle image captured by an imaging device and showing an interior of the vehicle; individually detecting an occupant inside the vehicle from the in-vehicle image; individually detecting an object present in the vehicle from the in-vehicle image; when it is detected from the in-vehicle image that the object has been moved by the occupant based on a detection result of the occupant and a detection result of the object, combining occupant information identifying the occupant who moved the object, object information identifying the object moved, and destination information identifying a destination position to which the object has been moved, and storing combined information in a memory, and presenting object position information, the object position information being information regarding a position of the object in the interior of the vehicle, to the occupant based on the combined information.

Still another aspect of the present invention is a computer-readable storage medium storing a vehicle information presentation program. The vehicle information presentation program causes a computer to perform: acquiring an in-vehicle image captured by an imaging device and showing an interior of the vehicle; individually detecting an occupant inside the vehicle from the in-vehicle image; individually detecting an object present in the vehicle from the in-vehicle image; when it is detected from the in-vehicle image that the object has been moved by the occupant based on a detection result of the occupant and a detection result of the object, combining occupant information identifying the occupant who moved the object, object information identifying the object moved, and destination information identifying a destination position to which the object has been moved, and storing combined information in a memory, and presenting object position information, the object position information being information regarding a position of the object in the interior of the vehicle, to the occupant based on the combined information.

### BRIEF DESCRIPTION OF THE DRAWINGS

The objects, features, and advantages of the present invention will become clearer from the following description of embodiments in relation to the attached drawings, in which:

FIG. 1 is a diagram describing a schematic configuration of a vehicle information presentation system;

FIG. 2 is a block diagram describing functional blocks of an information presentation apparatus constituting the vehicle information presentation system, and components connected to the information presentation apparatus via the network;

FIG. 3 is a flowchart describing a schematic procedure of object movement detection processing executed by a CPU of the information presentation apparatus;

FIG. 4 is a flowchart describing a schematic procedure of information presentation processing executed by the CPU of the information presentation apparatus; and

FIG. 5 is a diagram conceptually describing an example of a data table in which personal behavior characteristic information is recorded.

### DETAILED DESCRIPTION

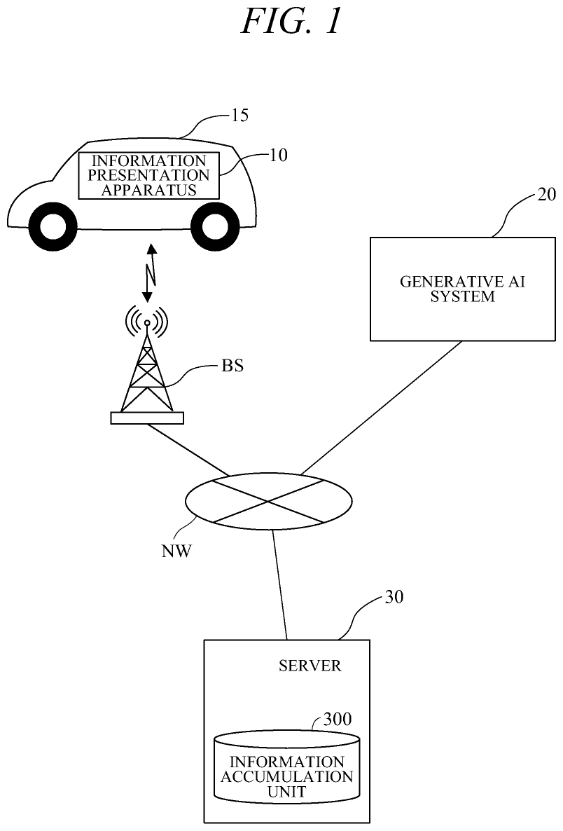

Hereinafter, an embodiment of the present disclosure will be described with reference to FIGS. 1 to 5. In all the drawings described below, common components are denoted by the same reference numerals, and repeated description is omitted. Note that not all the components shown in the following embodiments are essential components of the present disclosure.

FIG. 1 is a diagram describing a schematic configuration of a vehicle information presentation system. An information presentation apparatus 10 constituting a vehicle information presentation system is provided in a vehicle 15 such as a passenger car or a cargo vehicle, and can present, to an occupant, the place of a target article when the passenger (occupant) of the vehicle 15 is looking for an article in the vehicle. In addition, when the occupant parks the vehicle in a predetermined parking space and attempts to get off the vehicle, it is possible to present to the occupant an article that has a possibility of being mislaid in the vehicle.

The information presentation apparatus 10 may be independently provided in the vehicle 15, or may be a mobile terminal device mounted in the vehicle and implemented in an In-Vehicle Infotainment (IVI) device or the like that can be connected to the network NW via a wireless communication network.

The vehicle information presentation system includes an information presentation apparatus 10, a generative AI system 20, and a server 30, and the information presentation apparatus 10, the generative AI system 20, and the server 30 are mutually connected via a network NW such as the Internet. The information presentation apparatus 10 includes a wireless communication function unit, and is connected to the network NW via the wireless communication function unit and the base station BS.

The generative AI system 20 is an external processing device in which a learned model is implemented. As will be described in detail later, the generative AI system 20 receives an image obtained by photographing the vehicle interior, that is, an in-vehicle image, from the information presentation apparatus 10. Then, based on the received in-vehicle image, detection processing of individually detecting (recognizing) each of an occupant on the vehicle and an object present inside the vehicle can be performed.

A system provided in the vehicle 15 can detect an occupant on the vehicle and an object present inside the vehicle from the in-vehicle image, but for example, if the jacket is left unattended in an offhandedly folded manner on the seat surface of the rear seat, the outer shape of the jacket becomes unknown, and recognition becomes difficult in a system of small scale. The same applies to a situation where the smartphone is accommodated in the chest pocket of the occupant and only a part of the smartphone is shown in the in-vehicle image. Furthermore, the same applies to a situation where the face of the occupant is directed in a direction opposite to a imaging unit 130, the occupant is wearing sunglasses, or wearing a hat with a wide brim. It is possible to detect an occupant and an object with higher accuracy in a shorter time by using the generative AI system 20 that is well trained based on enormous teacher data.

As will be apparent in the following description, an occupant and an object existing inside the vehicle are detected by the generative AI system 20 based on the in-vehicle image, and information regarding the occupant and the object in the vehicle 15 extracted by the information presentation apparatus 10 is accumulated in an information accumulation unit 300 of the server 30 together with information regarding the situation of the vehicle 15 detected by the information presentation apparatus 10 and the like. Then, machine learning is performed in the server 30 based on the accumulated information. As a result, it is possible to learn in what state of the vehicle 15, a specific occupant moved what object, carried out what object from the vehicle, and the like. This learning result is accumulated in the information accumulation unit 300 as personal behavioral characteristic information in association with information that can uniquely identify the vehicle 15.

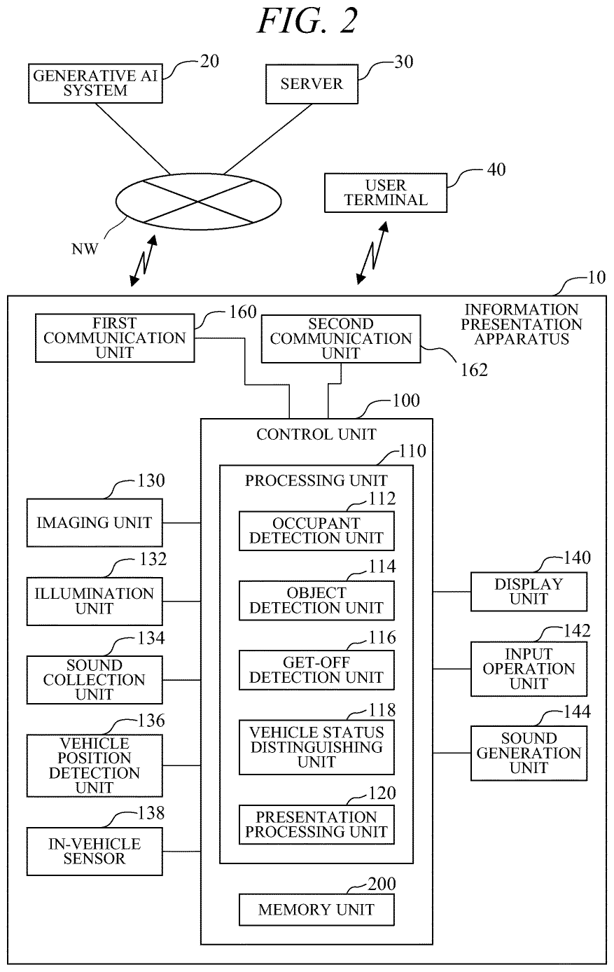

FIG. 2 is a block diagram describing functional blocks of the information presentation apparatus 10 constituting the vehicle information presentation system, and the generative AI system 20 and the server 30 connected to the information presentation apparatus 10 via the network NW.

The information presentation apparatus 10 includes a control unit 100. The control unit 100 includes a processing unit 110 and a memory unit 200. The processing unit 110 includes a CPU, and the processing unit 110 reads and executes a program stored in the memory unit 200, whereby the processing unit 110 can include each functional unit described below. In the following description, description is made assuming that the information presentation apparatus is mounted on the IVI, but as described above, the information presentation apparatus may be mounted on another in-vehicle device, for example, a car navigation device or a display audio (an audio device including a display), or may be a device independently provided in the vehicle 15.

The control unit 100 is connected to each of the imaging unit 130, an illumination unit 132, a sound collection unit 134, a vehicle position detection unit 136, an in-vehicle sensor 138, a display unit 140, an input operation unit 142, a sound generation unit 144, a first communication unit 160, and a second communication unit 162.

The imaging unit 130 can be a photographing device provided with a wide-angle photographing lens that is provided in the vehicle compartment of the vehicle 15, for example, in the vicinity of the center of the ceiling or the like, and can accommodate the entire vehicle compartment within the photographing field angle. Alternatively, a plurality of photographing devices installed at different positions in the vehicle compartment at different camera angles may be provided, and the entire vehicle compartment may be captured based on a plurality of pieces of image data obtained from each photographing device. At this time, some or all of the plurality of photographing devices may be devices for other purposes, such as a photographing device for an occupant monitoring system that detects the fatigue and state of an occupant When an occupant is riding on the vehicle, the imaging unit 130 photographs the inside of the vehicle at an interval of a fixed time to generate an in-vehicle image.

The illumination unit 132 is a device that illuminates the vehicle compartment, and can be a device capable of functioning as auxiliary light for photographing when illuminance (light amount) in the vehicle compartment is insufficient when the imaging unit 130 photographs the vehicle compartment. The illumination unit 132 may be configured to be capable of irradiating the vehicle compartment with light having a wavelength outside the visible range of human eyes, for example, infrared light so as not to affect the driver driving at night. Note that, in a case where photographing is performed using infrared light as auxiliary light, the obtained image is an image close to monochrome (depending on the relative illuminance between the ambient light and the infrared light at the time of photographing), but it is also possible to perform processing of estimating the color of the subject using the generative AI system 20.

The sound collection unit 134 is configured to be able to collect sound emitted by an occupant in the vehicle compartment. As the sound collection unit 134, a voice microphone can be used. In a case where a microphone is provided in the IVI, the microphone can also be used as the sound collection unit 134.

The vehicle position detection unit 136 is for detecting a geographical position of the vehicle 15, and can use, for example, a position measurement result obtained by processing an output from a Global Positioning System (GPS) sensor provided in a car navigation system, an output from the GPS sensor in the car navigation system, or the like. In the present specification, information obtained from the vehicle position detection unit 136 is referred to as position measurement information. The map information is accumulated in the memory unit 200, and it is possible to determine where the vehicle 15 is located by matching the position measurement information and the map information.

The in-vehicle sensor 138 includes various sensors provided in the vehicle 15. For example, the in-vehicle sensor 138 includes one or a plurality of a sensor capable of detecting On/Off of an ignition switch (in the case of an internal combustion engine vehicle, power switch in the case of an electric vehicle), a sensor capable of detecting that the selector of the transmission has been switched to position P, a sensor capable of detecting a state at which the parking brake is operating, a seating sensor capable of detecting that an occupant is seated on the seat, a sensor capable of detecting that the door or the tailgate has been unlocked, a door sensor capable of detecting that the door or the tailgate has been opened, and a sensor capable of detecting that the buckle of the seat belt has been unlocked. In addition, the in-vehicle sensor 138 may include a vehicle exterior temperature sensor capable of detecting a temperature outside the vehicle 15, a raindrop sensor for automatic wipers, and the like. Furthermore, the imaging unit 130 can also be used as the in-vehicle sensor 138.

The display unit 140 is a device that allows an occupant on the vehicle 15 to view graphic information such as an image, character information, and the like, and a flat panel display such as a liquid crystal display device or an organic EL display device can be used, and a display included in the IVI can also be used as the display unit 140.

The input operation unit 142 is used when the occupant makes some settings, instructions, requests, or the like to the information presentation apparatus 10, and for example, a touch panel provided on the display unit 140 can be used. The occupant can perform operations of inputting character information and selecting a desired one from a selection menu or the like displayed on the display unit 140 via the input operation unit 142. As another example of the input operation unit 142, any of a touch pad, a dial, a joystick-shaped operation member, and the like can be used. Then, by operating the operation member, an operation of selecting a character from a character list displayed on the display unit 140 or selecting a desired one from a selection menu displayed on the display unit 140 can be performed. It is also possible to recognize the utterance content of the occupant input via the sound collection unit 134 and accept the operation of the occupant.

As the sound generation unit 144, a speaker of an audio device provided in the vehicle 15 can be used. Alternatively, the information presentation apparatus 10 may include a dedicated amplifier and a speaker.

The first communication unit 160 connects the information presentation apparatus 10 to the network NW via a base station BS (FIG. 1) of a mobile communication system used for communication of a mobile terminal such as a smartphone, and enables information transmission with the generative AI system 20 and the server 30.

The second communication unit 162 can wirelessly connect the information presentation apparatus 10 and the user terminal 40 by using a communication technique such as Bluetooth (registered trademark), Wi-Fi (registered trademark), or optical communication using infrared rays. Instead of the wireless connection, the information presentation apparatus 10 and the user terminal 40 may be connected by wire using a cable. As the user terminal 40, a smartphone, a tablet Personal Computer (PC), a notebook PC, or the like can be used.

Next, a functional unit realized by the processing unit 110 included in the control unit 100 executing the information presentation processing program stored in the memory unit 200 will be described.

In conjunction with the photographing operation of the imaging unit 130 that repeatedly photographs the vehicle compartment at predetermined time intervals and outputs an image, the occupant detection unit 112 receives, from the generative AI system 20, a result of detection (recognition) of an occupant by the generative AI system 20 from the in-vehicle image obtained by the imaging unit 130, and individually extracts the detected occupant. For example, when the occupant seated on the driver seat and the occupant seated on the passenger seat are detected by the generative AI system 20, detection results (recognition results) of these occupants are individually extracted.

The object detection unit 114 receives, from the generative AI system 20, a result of detection (recognition) of an object present in the vehicle by the generative AI system 20 from the in-vehicle image obtained by the imaging unit 130, and individually extracts the detected object. For example, when it is detected that an occupant seated on a passenger seat possesses a smartphone and a blue bag, a white bag, and boxed tissue paper are placed on a seat surface of a rear seat, detection results (recognition results) of these objects are individually extracted.

The results extracted by the occupant detection unit 112 and the object detection unit 114 are stored in the memory unit 200. When it is detected that the occupant has moved an object present in the vehicle while the above-described operation is being repeatedly performed, information that can identify who has moved what object and to where is stored in the memory unit 200. That is, occupant information for identifying an occupant who has moved an object, object information for identifying the moved object, and movement destination information for identifying a position of the movement destination of the moved object are stored in combination as the first information. The first information can include the time when the movement of the object is detected, the position of the vehicle 15, and the like.

Note that even in a case where the object is located at the same place in the vehicle without being moved, the occupant information for identifying the occupant who has moved the object can be left blank and stored as the first information. In this case, information corresponding to the position where the object is currently detected can be stored as the movement destination information for identifying the movement destination of the object. For example, when the vehicle 15 suddenly stops and an object placed on the seat surface of the rear seat drops to the underfloor, the underfloor can be stored as the movement destination information.

It is assumed that an occupant seated on a rear seat stores an object that had been placed on a seat surface of the rear seat, for example, a smartphone, in a bag. In this case, the smartphone cannot be detected from the in-vehicle image output from the imaging unit 130. In the present specification, this state is referred to as a lost state. Similarly, even in a case where the blanket is placed over the bag placed on the seat surface of the rear seat, the state may be in a lost state. In such a case, the information for identifying the object that had been detected so far and the position where the object becomes the lost state (the position immediately before the lost state) can be stored in the memory unit 200 as the second information in association with the first information related to the object.

Meanwhile, the vehicle information presentation system is configured to be able to register in advance the user who owns the vehicle and his/her family, friends, and the like. For example, it is also possible to accumulate, as a data table, information obtained by combining personal feature information that can be used to recognize an individual, such as images of a face, a skeleton, and a physique, and personal identification information that can identify an individual, such as a name of the individual, and to configure such that it is possible to recognize who the detected occupant in the vehicle is and on which seat the occupant is seated based on the in-vehicle image. In this case, the first information can include personal identification information that can uniquely identify the occupant who has moved the object. The recognition of the registered individual may be performed in the information presentation apparatus 10 or may be performed in the generative AI system 20. If the personal identification information is included in the first information in this manner, for example, when an inquiry regarding the location of the smartphone owned by the specific person A is made by the occupant, a specific answer such as “Mr./Ms. B has put it in a blue bag in the back seat” can be made, and the occupant can save time and effort when searching for an object of interest, which increases convenience.

A get-off detection unit 116 detects the timing at which an occupant gets off the vehicle 15 and an operation of getting off the vehicle based on information obtained from the in-vehicle sensor 138. As a method of detecting the timing (operation) at which the occupant gets off the vehicle 15, the following can be performed as an example. That is, the timing when the parking brake is in the operating state, the shift selector of the transmission is set to the P position, the ignition switch (in the case of an internal combustion engine vehicle, power switch in the case of an electric vehicle) is detected to be turned off, or an operation of opening the door is further detected can be set as the get-off timing. In addition, it is also possible to set the get-off timing to a time when the image obtained by the imaging unit 130 is analyzed and an operation in which the occupant attempts to get off is detected.

A vehicle status distinguishing unit 118 will be described. As described above, the current position of the vehicle 15 can be known by matching the position measurement information obtained from the vehicle position detection unit 136 with the map information accumulated in the memory unit 200. For example, it can be determined that the vehicle 15 is located in a parking lot at the owner's home, a parking lot of a hospital, a parking lot of a theme park, a camping site, a parking lot of a large commercial facility, or the like.

Furthermore, in a case where the vehicle 15 includes a car navigation system, the information presentation apparatus 10 can obtain information of a destination set in the system. The same applies to a car navigation system realized by linking the user terminal 40 such as a smartphone carried by the occupant and the IVI included in the vehicle 15.

Furthermore, the information presentation apparatus 10 can acquire the schedule information of the owner (or passenger) of the vehicle 15 by linking the schedule management application installed in the user terminal 40 possessed by the occupant of the vehicle 15, for example, the driver, and the information presentation apparatus 10.

Information obtained as described above can be accumulated together with date and time information, and the information presentation apparatus 10 can learn a situation in which vehicle 15 is used (a use pattern of the vehicle). Alternatively, these pieces of information may be sent to the server 30, and the server 30 may learn the use pattern of the vehicle 15 based on the accumulated information.

Then, it is possible to estimate the usage purpose of the vehicle 15, the destination of the occupant who gets off from the vehicle, and the like with high accuracy based on the date and time when the vehicle 15 is used, calendar information regarding a day of the week, a holiday, and the like, and the above-described usage pattern.

The vehicle status distinguishing unit 118 is configured to be able to distinguish a vehicle status including at least one of a usage purpose of the vehicle 15, a destination, a parking position, and a destination of an occupant who gets off from the vehicle 15 based on the information regarding the current position, the destination, the schedule of the occupant, and the like of the vehicle 15 described above.

A presentation processing unit 120 roughly has two presentation functions. One is a function of issuing an inquiry to the information presentation apparatus 10 when an occupant in the vehicle 15 cannot find the location of an object placed in the vehicle, and presenting the location of the inquired object in response to the inquiry. The other is a function of presenting (calling attention to), to the occupant, an object having a possibility of being mislaid in the vehicle when the occupant parks the vehicle 15 and tries to get off the vehicle 15.

The occupant makes an inquiry regarding the location of the in-vehicle object by speaking to the sound collection unit 134 or operating the input operation unit 142. In response to the inquiry from the occupant, the presentation processing unit 120 searches and reads the first information corresponding to the object inquired by the occupant and the second information if any from the information stored in the memory unit 200, and presents the location of the object.

In a case where the presentation is performed based on the first information, the position in the vehicle where the inquired object is placed may be presented. As a method of presentation, presentation may be performed by emitting a voice from the sound generation unit 144, or presentation may be performed by displaying an image, character information, or the like on the display unit 140. At this time, a frame or the like indicating the position of the object can be displayed on the display unit 140 in an overlapping manner on the image of the vehicle compartment obtained by photographing by the imaging unit 130. In a case where the voice is emitted from the sound generation unit 144, the information presentation apparatus 10 may receive the voice data generated by the generative AI system 20 and emit the voice data from the sound generation unit 144.

In a case where the presentation is performed based on the second information, the presentation may be performed such as “The object you are looking for was last detected near the center of the rear seat, but after that, the object cannot be detected. Please check under the blanket that is placed on the rear seat and the floor surface of the vehicle compartment”, “Mr./Ms A's smartphone can detect that Mr./Ms. B had placed it in the blue bag.” and the like.

Next, a case will be described in which, when the occupant parks the vehicle 15 and attempts to get off the vehicle 15, that having a possibility of being mislaid in the vehicle is presented to the occupant. When it is detected that the occupant gets off the vehicle 15, the presentation processing unit 120 acquires information regarding the geographical position where the vehicle 15 is currently parked from the vehicle position detection unit 136. The presentation processing unit 120 also acquires information regarding the current status of vehicle 15 from vehicle status distinguishing unit 118. Next, the presentation processing unit 120 reads, from the memory unit 200, all of the first information and, if any, the second information accumulated in the memory unit 200 after the occupant gets on the vehicle 15 and starts traveling. Then, when the personal identification information is included in the read information, that is, when some or all of the detected occupants are registered users, personal behavior characteristic information corresponding to the personal identification information is acquired from the server 30. Then, the personal behavior characteristic information acquired from the server 30 is collated with the geographical position where the vehicle is currently parked and the current status of the vehicle 15, and it is determined whether or not to present information inquiring the occupant whether or not it is mislaid.

In accordance with the above determination, it is possible to change a presentation form of information asking whether it is mislaid. In short, when an affirmative determination is made, the information is presented, and when a negative determination is made, the information is not presented. Alternatively, even when the negative determination is made, it is also possible to present conservative information such as “Is there any possibility of mislaying?”.

At this time, it is also assumed that the target occupant who has been presented with the information does not bring out the object in the vehicle even though the information has been presented. The fact that the target occupant who has been presented did not bring out the object in the vehicle may indicate a possibility of a change in the behavior manner of bringing out the object in the vehicle by the occupant. In such a case, it is desirable to update the personal behavior characteristic information regarding the occupant stored in the information accumulation unit 300 of the server 30. As a method of updating, the personal behavior characteristic information may be replaced with one corresponding to the behavior manner of the last observed in-vehicle object being brought out, or information regarding the frequency of bringing out or not bringing out may be updated.

On the other hand, in a case where the registered user is not included in the occupants, the following can be performed. The information accumulation unit 300 of the server 30 accumulates learned data regarding a behavior manner of bringing out an in-vehicle object that can be generally taken by a person with respect to the geographical position where the vehicle 15 is currently parked or the current status. It is possible to determine whether or not to present information inquiring the occupant whether or not it is mislaying based on the learned data. Then, the form of presenting information can be changed based on the determination result.

On the other hand, in a case where the above data is not accumulated in the information accumulation unit 300 of the server 30, it is also possible to send, to the generative AI system 20, information indicating the geographical position where the vehicle 15 is currently parked or the current status and a prompt inquiring about a behavior manner of bringing out an in-vehicle object that can be generally taken by a person in that status. Then, based on the response from the generative AI system 20, it is possible to determine whether or not to present information inquiring the occupant whether or not it is mislaying. Then, the form of presenting information can be changed based on the determination result. At this time, it is also possible to send the answer from the generative AI system 20 to the information accumulation unit 300 of the server 30 together with the information indicating the geographical position where the vehicle 15 is currently parked and the current status. As a result, the server 30 can perform machine learning based on the answer obtained from the generative AI system 20.

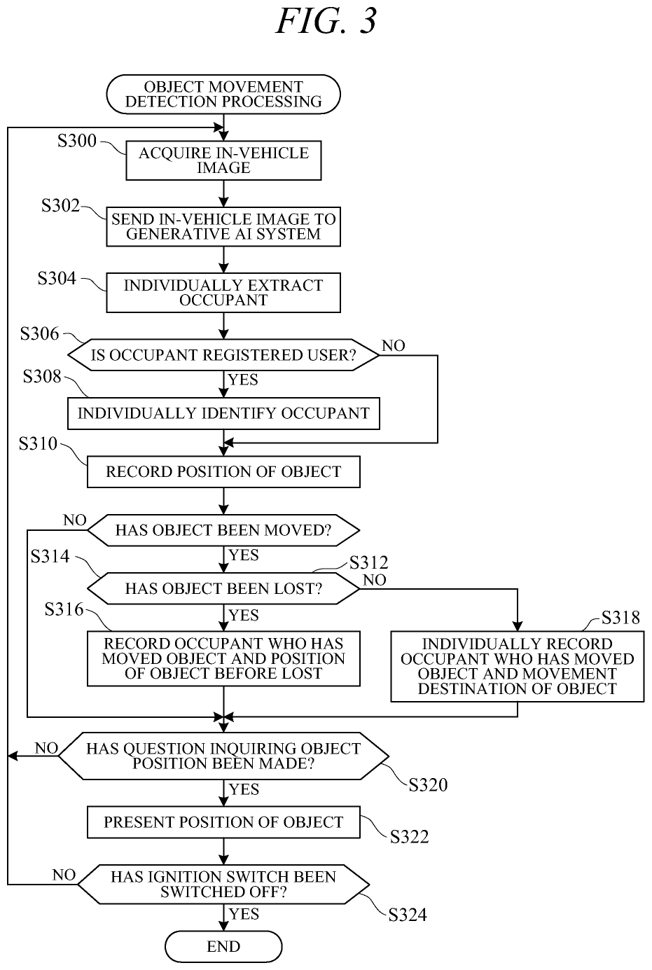

FIG. 3 is a flowchart describing a schematic procedure of object movement detection processing executed by the processing unit (CPU) 110 in the control unit (computer) 100 included in the information presentation apparatus 10. A program for executing the object movement detection processing is stored in the memory unit 200, and the processing unit 110 reads and executes the program. The execution of this program is started when, for example, an occupant gets into the vehicle 15, the driver turns on the ignition switch or the power switch, and thereafter releases the parking brake. In the following description, the vehicle 15 is described as an internal combustion engine vehicle that includes an ignition switch. In addition, the vehicle 15 may have a station wagon-type vehicle body structure, there is no partition between the passenger compartment and the luggage compartment, and the in-vehicle image obtained by the imaging unit 130 captures both the passenger compartment and the luggage compartment, but the imaging unit 130 may be provided in each of the passenger compartment and the luggage compartment. In addition, in the following description, when it is not necessary to distinguish a passenger compartment and a luggage compartment, a space in which an occupant or an object may exist in the vehicle 15 is simply referred to as a vehicle compartment.

In S300, the processing unit 110 acquires the in-vehicle image obtained by photographing by the imaging unit 130. In S302, the processing unit 110 sends the acquired in-vehicle image to the generative AI system 20. At this time, the processing unit 110 issues a prompt to the generative AI system 20 so as to individually detect objects other than those originally provided in the vehicle 15 and an occupant riding on the vehicle based on the sent in-vehicle image. The individual detection means that if a target to be detected is an object, each object is individually distinguished and detected. For example, it means that a smartphone housed in a blue notebook type case, a smartphone attached with a frame-shaped red protector, a blue bag, a white bag, a camping tool, a camera, a tripod, boxed tissue paper, and the like are all distinguished, and they are detected as two independent smartphones, two independent bags, a camping tool, a camera, a tripod, and a boxed tissue paper. If the target to be detected is an occupant, it means that an occupant (driver) seated in the driver's seat, an occupant seated in the passenger seat, an occupant seated on the right side in the advancing direction of the rear seat, and an occupant seated on the left side are individually distinguished and detected. The prompt to be issued to the generative AI system 20 further includes an instruction to detect which occupant has moved which object and to where when it is detected that any one of the occupants has moved any one of the objects based on the sent in-vehicle image. The processing of detecting that any one of the occupants has moved any one of the objects can be performed by detecting a difference between the in-vehicle images output in time series.

In S304, the processing unit 110 receives a result of detecting the occupant in the vehicle compartment from the generative AI system 20, and individually extracts the detected occupant. In S306, the processing unit 110 determines whether or not the extracted occupant is a registered user. The user to be registered may be an owner of the vehicle 15, a family member of the owner, a relative, a friend, or the like. By performing the user registration, it is possible to store, in the memory unit 200, a name or a nickname by which an individual can be identified, a face image or an image of a physique of each individual, an age, a gender, a usage form of the vehicle 15 (commutation, leisure, club activity), and a user profile such as driving/not driving the vehicle 15. The processing unit 110 collates the face image or the physique image of the occupant detected by the generative AI system 20 and extracted in S304 with the face image or the physique image included in the user profile, and if there is a matching user, an affirmative determination is made in S306. When an affirmative determination is made in S306, the processing proceeds to S308, and the occupant extracted in S304 is individually identified. Accordingly, for example, it is possible to identify that the occupant A is seated on the driver seat, the occupant B is seated on the passenger seat, and the occupant C is seated on the rear seat. Note that the processing of S306 and S308 is performed for each occupant seated on each seat in the vehicle compartment. When a negative determination is made in the determination in S306, the processing proceeds to S310.

In S310, the processing unit 110 receives a result of detecting an object in the vehicle compartment from the generative AI system 20, and individually extracts the detected object. Then, information that can identify the detected object and the detection position of the object is recorded. As will be described in detail later, when it is detected that the object in the vehicle compartment is moved by the occupant, the processing unit 110 combines occupant information for identifying the occupant who has moved the object, object information for identifying the moved object, and movement destination information for identifying the position of the movement destination of the moved object, and stores the combined information in the memory unit 200 as the first information. However, there is also a case where it is not moved and continues to be located at the same place in the vehicle compartment For the object whose movement is not detected, in S310, the occupant information for identifying the occupant who has moved the object is left blank, and as the movement destination information for identifying the movement destination of the object, that in which the information corresponding to the position where the object is currently detected is set is stored in the memory unit 200 as the first information. Since the processing from S300 to S310 is repeatedly executed, it is not always necessary to update the first information corresponding to the object while the movement of the object once detected and whose first information has been stored is not detected. Therefore, while the movement of the object once detected and whose first information has been stored is not detected, the processing of object position recording in S310 may be omitted, or the first information to be stored in the memory unit 200 may be overwritten with the same (unchanged) information. Alternatively, a time stamp that can identify the time at the time of object detection can be added to the first information and sequentially stored. When a series of pieces of the first information to which the time stamp is added is referred to later, it is possible to trace how the object has moved in the vehicle compartment with the elapse of time.

In S312, the processing unit 110 determines whether or not the object extracted in S310 has been moved. When an affirmative determination is made in S312, the processing unit 110 determines in S314 whether or not an object is lost, that is, an object that has been captured in the image photographed by the imaging unit 130 so far has moved to a position (blind spot) that cannot be captured by the imaging unit 130.

In S316, which is the branching destination when an affirmative determination is made in S314, the processing unit 110 stores, in the memory unit 200, second information obtained by combining information capable of identifying the occupant who has moved the object in the lost state with information capable of identifying the position of the object detected immediately before the lost state. In a case where the first information is stored in the memory unit 200 before the object is lost, the second information is stored in association with the first information. At this point, in a case where the occupant is individually identified in S308, the information regarding the occupant who has moved the object in the first information and the second information is replaced with the information that can identify the individual, or is added with the information that can identify the individual. As described above, the first information and the second information are stored in association with each other, and the information that can identify an individual is included in the first information and the second information, so that a more specific response can be made when the occupant asks about the location of the object later. For example, a response such as “It has been confirmed that Mr./Ms. has moved the inquired smartphone to the vicinity of the seat back of the driver's seat, but the position thereafter is unknown” or the like can be made. Based on this response, the occupant can search for the smartphone in the vicinity of the seat back of the driver's seat and find the smartphone accommodated in the seat back pocket of the driver's seat.

In S318, which is the branching destination when a negative determination is made in S314, the processing unit 110 stores, in the memory unit 200, first information obtained by combining occupant information for identifying the occupant who has moved the object, object information for identifying the moved object, and movement destination information for identifying the position of the movement destination of the moved object. At this point, in a case where the occupant is individually identified in S308, the information regarding the occupant who has moved the object in the first information is replaced with the information that can identify the individual, or is added with the information that can identify the individual. When the vehicle 15 is suddenly applied with brake and the object placed on the seat surface of the rear seat moves to the floor surface, the occupant information for identifying the occupant who has moved the object is set blank, and the first information in which the information corresponding to the floor surface is set as the movement destination is stored in the memory unit 200. When it is detected that the occupant seated on the rear seat picks up the object dropped on the floor surface and returns the object to the rear seat surface, the first information of the object picked up is updated correspondingly. In addition, when the object once lost can be captured again by the imaging unit 130, the second information of the object can be erased. Alternatively, the second information may be left, and the history of the position where the object is detected may be referred to later.

When a negative determination is made in the determination of S312, the processing proceeds to S320. The processing from S312 to S318 described above is performed on all objects detected in the vehicle compartment.

In S320, the processing unit 110 determines whether or not a question inquiring the object position is made from the occupant. When an affirmative determination is made in S320, the processing proceeds to S322, and the first information corresponding to the inquired object and the second information if any are read from the memory unit 200, and the information regarding the position of the object is presented to the occupant.

In S324, the processing unit 110 determines whether or not the ignition switch is switched off, and ends the object movement detection processing when an affirmative determination is made. When a negative determination is made in S324, the processing returns to S300, and the processing described above is performed again. When a negative determination is made in S320, the processing returns to S300.

Since the processing described above is repeatedly performed until the ignition switch is detected to be turned off, for example, even when the vehicle 15 stops on the road shoulder and picks up a person waiting outside and allows the person to get on the vehicle 15, the information stored in the memory unit 200 can be updated corresponding to the newly detected occupant.

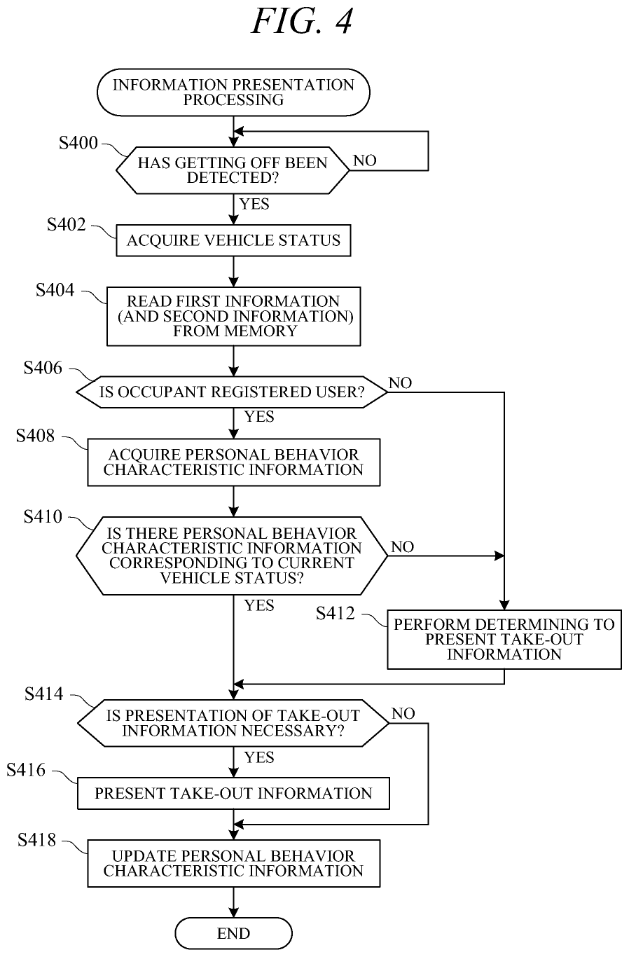

FIG. 4 is a flowchart describing a schematic procedure of information presentation processing executed by the processing unit (CPU) 110 in the control unit (computer) 100 included in the information presentation apparatus 10. A program for executing the information presentation processing is stored in the memory unit 200, and the processing unit 110 reads and executes the program. The execution of this program is started, for example, when it is detected that an occupant riding on the vehicle 15 gets off.

In S400, the processing unit 110 determines whether or not an operation of getting off the vehicle 15 by the occupant is detected. As described above, the detection of the operation of the occupant getting off the vehicle can be determined as the operation of the occupant getting off being performed when it is detected that the parking brake is in the operating state, the shift selector of the transmission is set to the P position, and the ignition switch is turned off, or when it is further detected that the operation of opening the door is performed. In addition, it is possible to detect an operation of the occupant getting off when a change pattern of a signal output from the seating sensor is detected, unbuckling of the seat belt is detected, an operation in which the occupant tries to get off the vehicle is detected by analyzing the image obtained by the imaging unit 130, and the like.

While a negative determination is made in S400, the determination in S400 is repeatedly performed. When an affirmative determination is made in S400, the processing proceeds to S402, and the processing unit 110 acquires the vehicle status. As described above, the vehicle status includes at least one of the usage purpose of the vehicle 15, the destination of the vehicle 15, the parking position of the vehicle 15, and the destination of the occupant who gets off the vehicle 15. Since the method for acquiring the vehicle status has already been described, the description thereof will be omitted here.

In S404, the processing unit 110 reads the first information corresponding to each object detected in the vehicle compartment of the vehicle 15 and the second information if any from the memory unit 200. Then, it is determined in S406 whether or not information that can identify an individual is included in the read information. When an affirmative determination is made in S406, the processing proceeds to S408, and the personal behavior characteristic information of the individual identified by the information that can identify the individual in the first information and the second information is acquired. Specifically, the processing unit 110 accesses the server 30 and acquires personal behavior characteristic information corresponding to information that can identify an individual included in the first information and the second information.

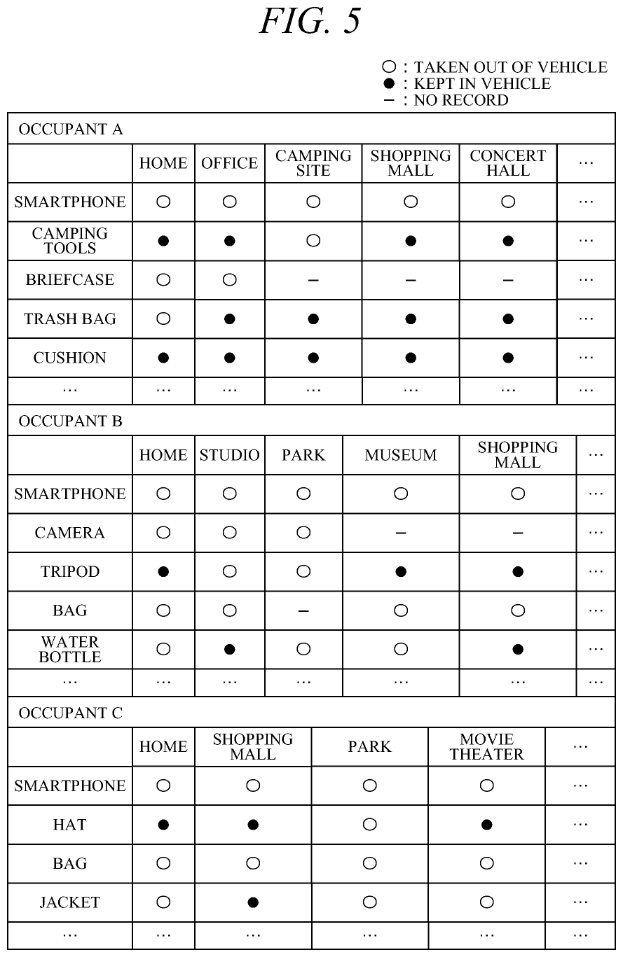

FIG. 5 is a diagram conceptually describing an example of a data table in which personal behavior characteristic information is recorded. FIG. 5 illustrates a state in which the personal behavior characteristics of the occupant A, the occupant B, and the occupant C are recorded (registered) in the data table. The personal behavior characteristic information means information recorded in correspondence with a vehicle status regarding a behavior manner of taking out the belongings, that is, a usage purpose of the vehicle 15, a destination of the vehicle 15, a parking position of the vehicle 15, a destination of an occupant who gets off the vehicle 15, and the like of whether or not a specific individual takes out an object in the vehicle compartment when getting off the parked vehicle 15.

In the example illustrated in FIG. 5, for example, the personal behavior characteristic of the occupant A corresponding to the smartphone possessed by the occupant A corresponds to the behavior manner of taking out the belongings of always taking out the belongings regardless of the vehicle status. The personal behavior characteristic with respect to the camping tool corresponds to a behavior manner of taking out the belongings of taking out the camping tool to the outside of the vehicle only when the usage purpose of the vehicle 15 is camping, the destination of the vehicle 15 is a camping site, the parking position of the vehicle is a parking lot annexed to the camping site, or the destination of the occupant A who gets off the vehicle 15 is the camping site, and leaving the camping tool in the vehicle compartment in other vehicle statuses. That is, the personal behavior characteristic of the occupant A indicates that the occupant A always keeps the camping tool in the vehicle compartment and does not take the camping tool out of the vehicle even when returning home. The personal behavior characteristic for the briefcase indicates that the briefcase is taken out of the vehicle in a situation where it is determined from the vehicle status that when the occupant A comes home or the occupant A who gets off the vehicle 15 goes to an office, and there is no record in other situations. Similarly, the personal behavior characteristics of the occupant A indicate that the trash bag is taken out of the vehicle only when the occupant A returns home, and the cushion is always kept in the vehicle at any time.

For occupants B and C as well, personal behavior characteristics corresponding to each vehicle status are recorded for belongings different from those of occupant A. The data table of the personal behavior characteristic information illustrated in FIG. 5 is updated as needed. For example, when new user registration is made, the server 30 performs processing of adding a new occupant and personal behavior characteristic information corresponding to the new occupant to the data table in response to the new user registration. The personal behavior characteristic information in FIG. 5 is updated as needed in the server 30 in response to the processing illustrated in FIG. 4 being repeatedly performed. Therefore, even if the behavior manner of taking out the belongings of each occupant changes with the elapse of time, the personal behavior characteristic information corresponding to the change is recorded. Note that the personal behavior characteristic information updated and managed by the server 30 may be periodically sent to the information presentation apparatus 10 and accumulated in the memory unit 200. With this configuration, the processing unit 110 does not need to access the server 30 when acquiring the personal behavior characteristic information in S408, and the processing load of the server 30 can be reduced.

The description returns to FIG. 4. In S410, the processing unit 110 determines whether or not the personal behavior characteristic information related to the vehicle 15 and corresponding to the current vehicle status acquired in S402 is included in the data table illustrated in FIG. 5. When an affirmative determination is made in S410, the processing proceeds to S414.

The processing in S412, which is the branch destination in a case where a negative determination is made in S406 or a negative determination is made in S410, will be described. The negative determination in S406 means that there is no registered user among the occupants who have moved some kind of object in the vehicle compartment of the vehicle 15. The negative determination is made in S410 means that there is no personal behavior characteristic information corresponding to the current vehicle status. That is, there is no personal behavior characteristic information corresponding to the combination of the current passenger, the vehicle status, and the type of object. When a negative determination is made in any one of S406 and S410, the personal behavior characteristic information does not exist. In that case, the processing unit 110 accesses the server 30, and issues an instruction to the server 30 to determine what kind of behavior manner of taking out belongings is generally taken for the combination of the object detected in the vehicle compartment and the current vehicle status. In the server 30, the behavior manners of taking out belongings collected from many vehicles connected to the server 30 are accumulated, and machine learning is performed. For example, even if the occupant in the vehicle 15 cannot be identified, the occupant is estimated to go to the movie theater from the vehicle status, and when the jacket is placed in the vehicle compartment, it can be determined that the jacket should be taken out in preparation for the movie theater being too cold. When the processing in S412 is ended, the processing unit 110 performs the processing in S414.

In S414, the processing unit 110 determines whether there is an object that needs to be presented to the occupant who is about to get off so as to be taken out of the vehicle among the objects existing in the vehicle compartment, in accordance with the current vehicle status. For example, if the smartphone possessed by the occupant A who is about to get off is placed somewhere in the vehicle compartment, an affirmative determination is made in S414 in correspondence with all the vehicle statuses recorded in correspondence with the occupant A in the data table of FIG. 5. Similarly, for camping tools, an affirmative determination is made in S414 only when the vehicle status is related to the camping site. As a result of determining to present take-out information in S412, when it is determined that information is to be presented, an affirmative determination is made in S414.

When an affirmative determination is made in S414, the processing unit 110 performs processing of presenting take-out information in S416. As a result, it is possible to present, to the occupant who has started the getting-off operation, to take out the specific object left in the vehicle by voice via the sound generation unit 144. Alternatively, a warning sound can be emitted from the sound generation unit 144, and a specific object can be displayed on the display unit 140 so as to be taken out of the vehicle. When a negative determination is made in S414, the processing proceeds to S418.

In S418, the processing unit 110 performs processing of updating the personal behavior characteristic information. This processing is processing of sending, to the server 30, information corresponding to a currently detected vehicle status, information for identifying an occupant when the occupant is a registered user, information for identifying an object taken out when the occupant gets off the vehicle, and information for identifying an object left in the vehicle compartment without being taken out, together with information that can uniquely identify the vehicle 15. By performing this processing, even if the behavior manner of taking out the belongings of each occupant changes with the elapse of time, the server 30 can perform the machine learning in correspondence with the change.

In the processing of S418, when the date and time when the occupant gets off the vehicle, the determination result of the raindrop sensor for wiper operation determination, the detection result of the vehicle exterior temperature detection sensor, and the like are transmitted together, the accuracy of the machine learning performed by the server 30 can be improved.

According to the present embodiment, the following operations and effects are achievable.
(1) The vehicle information presentation apparatus 10 (FIG. 2) includes an imaging unit 130 for photographing an inside of a vehicle and outputting an in-vehicle image, an occupant detection unit 112 (FIG. 2) for individually detecting an occupant inside the vehicle 15 (FIG. 1) from the in-vehicle image, an object detection unit 114 for individually detecting an object present in the vehicle from the in-vehicle image, a first information memory unit 200 for storing, as first information, a combination of occupant information for identifying an occupant who has moved an object, object information for identifying a moved object, and movement destination information for identifying a position of a movement destination of the moved object when it is detected that the object has been moved by the occupant from the in-vehicle image based on an occupant detection result by the occupant detection unit 112 and an object detection result by the object detection unit 114, and a presentation processing unit 120 for presenting, to the occupant, object position information that is information related to the position of the object in the vehicle based on the first information.

According to this, it is possible to present who has moved what and to where to the occupant who searches for an object in the vehicle, and it is possible to easily search for an object of interest in the vehicle.
(2) The vehicle information presentation apparatus 10 further includes a get-off detection unit 116 (FIG. 2) for detecting a get-off timing at which the occupant tries to get off the vehicle 15, and the presentation processing unit 120 presents the occupant with the object position information when the get-off detection unit 116 detects the get-off timing.

According to this, the vehicle information presentation apparatus can alert the occupant who tries to get off the vehicle to take out the object outside the vehicle. In addition, since it is possible to present where the object is, the occupant can easily find the object of interest.
(3) The vehicle information presentation apparatus 10 further includes a second information memory unit 200 for storing, as second information, a position of an object in a lost state where the object cannot be detected after the object detection unit 114 detects the object present inside the vehicle in association with the first information, and the presentation processing unit 120 presents the object position information to the occupant based on the first information and the second information.

According to this, as a result of the occupant accommodating the smartphone in the bag, for example, and the lost state is obtained, the position of the object in the lost state can be presented to the occupant, so that the occupant can easily find the object of interest.
(4) In the vehicle information presentation apparatus 10, the occupant detection unit 112 is configured to be able to distinguish whether an occupant riding in the vehicle coincides with any of registered users registered in advance, and in a case where it is determined that the occupant riding in the vehicle coincides with any of registered users, personal identification information that is information capable of identifying an individual that matches among the registered users is included in the occupant information.

According to this, when the position of the object in the vehicle is presented, it is possible to specifically indicate who has moved the object, and thus the occupant can easily find the object of interest.
(5) In the vehicle information presentation apparatus 10, the object detection unit 114 is further configured to be able to identify each of the detected objects, object identification information for identifying the detected object is included in the object information, and the presentation processing unit 120 changes the presentation form of the object position information according to the combination of the occupant information and the object information.

According to this, it is possible to present the object position information to the occupant in accordance with the behavior manner of taking out the in-vehicle object different for each occupant, and it is possible to present accurate information for each occupant.
(6) The vehicle information presentation apparatus 10 further includes a vehicle status distinguishing unit 118 for distinguishing a vehicle status including at least one of a usage purpose of the vehicle 15, a destination of the vehicle 15, a parking position of the vehicle 15, and a destination of an occupant who gets off the vehicle 15, and the presentation processing unit 120 changes a presentation form of the object position information based on the first information and the vehicle status distinguished by the vehicle status distinguishing unit 118.

According to this, since the object position information can be presented to the occupant in a form corresponding to a combination of the occupant and the vehicle status, the object position information can be more accurately presented to the occupant according to the occupant and the vehicle status.
(7) The vehicle information presentation apparatus 10 further includes inquiry reception units 142, 134 for accepting an inquiry regarding a position of an object present in the vehicle 15 from an occupant, and when the inquiry reception units 142, 134 accept the inquiry, the presentation processing unit 120 presents the object position information to the occupant.

According to this, when the occupant is looking for an article in the vehicle compartment, an inquiry regarding the position of the object can be made, and the object position information can be presented in response to the inquiry, so that the occupant can easily find the object to he/she is looking for.
(8) The vehicle information presentation apparatus 10 further includes an image display unit 140 for displaying an image for the occupant, and when presenting the object position information to the occupant, the presentation processing unit 120 displays, on the image display unit 140, an image that can identify a position of an object of interest of the occupant.

According to this, since the occupant can know the position of the object by viewing the image, the occupant can easily find the article of interest.
(9) The vehicle information presentation apparatus 10 further includes a sound collection unit 134 capable of collecting an utterance of the occupant and a sound generation unit 144 capable of generating voice toward the occupant, and the inquiry reception unit 134 accepts an inquiry by an utterance from the occupant regarding a position of an object present in the vehicle 15 via the sound collection unit 134, and the presentation processing unit 120 presents the object position information to the occupant by voice via the sound generation unit 144.

According to this, the occupant can inquire about the position of the object by voice and can receive the object position information by voice, and can receive the object position information while concentrating on the driving operation of the vehicle and present the object position information to the occupant seated on any seat in the vehicle.
(10) In the vehicle information presentation apparatus 10, the presentation processing unit 120 presents the object position information to the occupant when the get-off detection unit 116 detects the getting-off timing of the occupant in a state where the object moved by the occupant is left unattended in the vehicle.

According to this, it is possible to alert the occupant who is about to get off as to whether the occupant has forgotten to take out the object in the vehicle to the outside of the vehicle.
(11) In the vehicle information presentation apparatus 10, the occupant detection unit 112 outputs the in-vehicle image to the external processing device 20 that is installed outside the vehicle 15 and is mounted with the learned model, the external processing device 20 capable of performing the detection processing of individually detecting each of the occupant riding in the vehicle and the object present inside the vehicle based on the input in-vehicle image, and when the processing result of the detection processing output from the external processing device 20 is input, individually detects the occupant riding in the vehicle based on the processing result.

According to this, each of the occupants in the vehicle compartment can be more reliably detected by the external processing device on which the learned model is mounted.
(12) In the vehicle information presentation apparatus 10, the object detection unit 114 outputs the in-vehicle image to the external processing device 20, and when the processing result of the detection processing output from the external processing device 20 is input, individually detects the object present inside the vehicle based on the processing result.

According to this, each of the objects present in the vehicle compartment can be more reliably detected by the external processing device on which the learned model is mounted.
(13) In the vehicle information presentation apparatus 10, an external server 30 installed spaced apart from the vehicle 15, the external server 30 accumulating the first information and the vehicle status distinguished by the vehicle status distinguishing unit 118 in association with vehicle identification information for uniquely identifying the vehicle 15, and performing machine learning for each vehicle 15 uniquely identified with respect to a relation between the vehicle status distinguished by the vehicle status distinguishing unit 118 and a behavior of moving an object inside the vehicle by an occupant is connected to the vehicle information presentation apparatus 10 in an information transmittable manner, and the presentation processing unit 120 changes a presentation form of the object position information based on a result of referring to a learning result of the external server 30.

According to this, the processing load of the vehicle information presentation apparatus 10 can be reduced by causing the external server 30 to perform the machine learning processing that requires more resources.
(14) The vehicle information presentation method (FIG. 3) includes photographing an inside of a vehicle by a imaging unit 130 (FIG. 2) and outputting an in-vehicle image (S302 in FIG. 3), individually detecting an occupant riding in the vehicle from the in-vehicle image (S304), individually detecting an object present inside the vehicle from the in-vehicle image (S310), when it is detected that the object has been moved by the occupant from the in-vehicle image (S312: YES) based on the occupant detection result obtained by individually detecting the occupant and the object detection result obtained by individually detecting the object, storing (S318 in FIG. 3), in a first information memory unit 200 (FIG. 2), a combination of occupant information for identifying an occupant who has moved an object, object information for identifying a moved object, and movement destination information for identifying a position of a movement destination of the moved object as first information, and presenting (S322), to the occupant, object position information that is information related to the position of the object in the vehicle based on the first information.

According to this, it is possible to present who has moved what and to where to the occupant who searches for an object in the vehicle, and it is possible to easily search for an object of interest in the vehicle.
(15) The vehicle information presentation program (FIG. 3) causes a computer 100 (FIG. 2) to photograph an inside of a vehicle by a imaging unit 130 (FIG. 2) and output an in-vehicle image (S302 in FIG. 3), individually detect an occupant riding in the vehicle from the in-vehicle image (S304), individually detect an object present inside the vehicle from the in-vehicle image (S310), when it is detected that the object has been moved by the occupant from the in-vehicle image (S312: YES) based on the occupant detection result obtained by individually detecting the occupant and the object detection result obtained by individually detecting the object, store (S318 in FIG. 3), in a first information memory unit 200 (FIG. 2), a combination of occupant information for identifying an occupant who has moved an object, object information for identifying a moved object, and movement destination information for identifying a position of a movement destination of the moved object as first information, and present, to the occupant, object position information that is information related to the position of the object in the vehicle based on the first information.

According to this, it is possible to present who has moved what and to where to the occupant who searches for an object in the vehicle, and it is possible to easily search for an object of interest in the vehicle.

The above embodiment can be combined as desired with one or more of the aforesaid modifications. The modifications can also be combined with one another.

According to the present disclosure, it is possible to present who moved what to where to an occupant who is looking for an object in the vehicle, and to easily search for an object of interest in the vehicle.

Above, while the present invention has been described with reference to the preferred embodiments thereof, it will be understood, by those skilled in the art, that various changes and modifications may be made thereto without departing from the scope of the appended claims.

What is claimed is:

1. A vehicle information presentation apparatus comprising:
an imaging device configured to capture an interior of a vehicle and output an in-vehicle image;
a microprocessor; and
a memory connected to the microprocessor, wherein
the microprocessor is configured to perform:
individually detecting an occupant inside the vehicle from the in-vehicle image;
individually detecting an object present in the vehicle from the in-vehicle image;
when it is detected from the in-vehicle image that the object has been moved by the occupant based on a detection result of the occupant and a detection result of the object, combining occupant information identifying the occupant who moved the object, object information identifying the object moved, and destination information identifying a destination position to which the object has been moved, and storing combined information as first information in the memory, and
presenting object position information, the object position information being information regarding a position of the object in the interior of the vehicle, to the occupant based on the first information.

2. The vehicle information presentation apparatus according to claim 1, wherein
the microprocessor is further configured to perform:
detecting an exit timing at which the occupant is about to exit from the vehicle; and
presenting the object position information to the occupant when the exit timing is detected.

3. The vehicle information presentation apparatus according to claim 1, wherein
the microprocessor is further configured to perform:
after detecting the object existing in the interior of the vehicle, storing a position of the object when entering a lost state in which the object can no longer be detected as second information in the memory in association with the first information, and
presenting the object position information to the occupant based on the first information and the second information.

4. The vehicle information presentation apparatus according to claim 1, wherein
the microprocessor is configured to perform:
the detecting of the occupant including determining whether an occupant who has boarded the vehicle matches any of pre-registered registered users, and
when it is determined that the occupant who has boarded the vehicle matches any of the registered users, including personal identification information in the occupant information, the personal identification information being information capable of identifying the matching individual among the registered users.

5. The vehicle information presentation apparatus according to claim 4, wherein
the microprocessor is configured to perform:
the detecting of the object including identifying each of detected objects, including object identification information indicating a result of the identifying in the object information, and
the presenting including changing a presentation form of the object position information according to a combination of the occupant information and the object information.

6. The vehicle information presentation apparatus according to claim 4, wherein
the microprocessor is further configured to perform:
determining a vehicle situation including at least one of a purpose of use of the vehicle, a destination of the vehicle, a parking position of the vehicle, and a destination of an occupant who has exited from the vehicle, and
changing a presentation form of the object position information based on the first information and the determined vehicle situation.

7. The vehicle information presentation apparatus according to claim 1, wherein
the microprocessor is further configured to perform:
receiving an inquiry from the occupant regarding a position of an object existing in the interior of the vehicle; and
when the inquiry is received, presenting the object position information to the occupant.

8. The vehicle information presentation apparatus according to claim 7, further comprising:
a display device configured to display an image to the occupant, wherein
the microprocessor is configured to perform:
the presenting including, when presenting the object position information to the occupant, displaying an image capable of identifying a position of an object of interest to the occupant on the display device.

9. The vehicle information presentation apparatus according to claim 7, further comprising:
a microphone capable of collecting an utterance of the occupant; and
a speaker capable of generating voice toward the occupant, wherein
the microprocessor is configured to perform:
the receiving of the inquiry including receiving an inquiry by an utterance from the occupant regarding a position of an object present in the interior of the vehicle via the microphone, and
the presenting including presenting the object position information to the occupant by voice via the speaker.

10. The vehicle information presentation apparatus according to claim 2, wherein
the microprocessor is configured to perform:
the presenting including presenting the object position information to the occupant when the exit timing is detected while the object moved by the occupant is left in the interior of the vehicle.

11. The vehicle information presentation apparatus according to claim 1, wherein
the microprocessor is configured to perform:
the detecting of the occupant including:
outputting the in-vehicle image to an external processing device installed outside the vehicle and including a learned model, the external processing device being capable of performing detection processing for individually detecting each of occupants in the vehicle and objects present in the vehicle based on the in-vehicle image; and
when a processing result of the detection processing output from the external processing device is input, individually detecting the occupants in the vehicle based on the processing result.

12. The vehicle information presentation apparatus according to claim 11, wherein
the microprocessor is configured to perform:
the detecting of the object including:
outputting the in-vehicle image to the external processing device, and
when a processing result of the detection processing output from the external processing device is input, individually detecting objects present in the vehicle based on the processing result.

13. The vehicle information presentation apparatus according to claim 6, wherein
an external server installed remotely from the vehicle, the external server accumulating the first information and the vehicle situation determined in association with vehicle identification information for uniquely identifying the vehicle, and performing machine learning for each of vehicles uniquely identified regarding a relationship between the vehicle situation determined and an action of moving an object in the vehicle by the occupant, is connected to the microprocessor in an information-communicable manner, and
the microprocessor is configured to perform:
the presenting including changing a presentation form of the object position information based on a result of referring to a learning result of the external server.

14. A vehicle information presentation method comprising:
acquiring an in-vehicle image captured by an imaging device and showing an interior of a vehicle;
individually detecting an occupant inside the vehicle from the in-vehicle image;
individually detecting an object present in the vehicle from the in-vehicle image;
when it is detected from the in-vehicle image that the object has been moved by the occupant based on a detection result of the occupant and a detection result of the object, combining occupant information identifying the occupant who moved the object, object information identifying the object moved, and destination information identifying a destination position to which the object has been moved, and storing combined information in a memory, and
presenting object position information, the object position information being information regarding a position of the object in the interior of the vehicle, to the occupant based on the combined information.

15. A computer-readable storage medium storing a vehicle information presentation program, wherein the vehicle information presentation program causes a computer to perform:
acquiring an in-vehicle image captured by an imaging device and showing an interior of a vehicle;
individually detecting an occupant inside the vehicle from the in-vehicle image;
individually detecting an object present in the vehicle from the in-vehicle image;
when it is detected from the in-vehicle image that the object has been moved by the occupant based on a detection result of the occupant and a detection result of the object, combining occupant information identifying the occupant who moved the object, object information identifying the object moved, and destination information identifying a destination position to which the object has been moved, and storing combined information in a memory, and
presenting object position information, the object position information being information regarding a position of the object in the interior of the vehicle, to the occupant based on the combined information.
